(19) United States
(12) Patent Application Publication
(10) Pub. No.: US 2018/0369727 A1
(43) Pub. Date: Dec. 27, 2018

(54) Modular Sectorised Filter Element

(71) Applicant: NOVHIDRO, S.L., Torre Pacheco (ES)

(72) Inventor: Salvador ROS ROCA, Roldan (ES)

(21) Appl. No.: 15/797,551

(22) Filed: Oct. 30, 2017

(30) Foreign Application Priority Data
Jun. 22, 2017 (ES) P-201700644

(51) Int. Cl. B01D 35/22; B01D 29/03; B01D 29/58

(52) U.S. Cl. CPC B01D 35/22; B01D 2201/4038; B01D 29/58; B01D 29/038

(57) ABSTRACT

Modular sectorised filtering element consisting of a flat modular filter element whose surface has at least two concentric strips, the stacking of which forms a filter surface. This module allows the sectorised filtration of the fluid passing through it, with the possibility of the same filter surface also having parts dedicated simultaneously to filtration, washing, different degrees of filtration, etc. It is composed of an outer perimeter strip (1) with a zig-zag groove (4), an intermediate perimeter strip (2) with holes (6), which have radial walls (7), and concentric separation walls (8) of a stackable shape, and an inner perimeter strip (3) with a configuration similar to the outer strip (1).

### OBJECT OF THE INVENTION

This invention relates to a modular filter element, comprising a part or element the stacking of which forms a filter surface. Said module allows the filter of the fluids that pass through it in a sectorised way so that, unlike the filter modules in the current state of the art, in one single filter surface there are simultaneously parts dedicated to filtration, parts dedicated to washing, parts with different degrees of filtration, etc., thereby increasing the possibilities of using the filter made up of a number of said modules.

More specifically, the shape of the modular filter element consists of a flat element whose surface has at least two differentiated concentric strips, where one of them filters the fluid, then passes it from or to the other type of strip, formed by radially positioned holes, which with the stacking of modules form independent channels for the water to pass through.

### SCOPE OF APPLICATION OF THE INVENTION

This invention will the used mainly in the manufacture of filter units for piping installations for all types of fluids, being useful for industries dedicated to irrigation, petrochemical and pneumatic installations, etc.

### BACKGROUND OF THE INVENTION

There are many types of fluid piping installations where particle filtration is required. Given this need, several technologies have been developed focused on the filtration of particles, the most notable are:
Bag filters.
Mesh filters.
Cartridge filters.
Ring filters.
Deep bed filters (sand, active carbon . . . ).
Rotary screens.
Cloth filters.

All these systems have their own peculiarities that turn them into technologies for use in very specific installations. The technology developed herein was devised to solve the main problems of two of the most widespread technologies, i.e. mesh filters and ring filters.

One of the main problems in filter installations today is the fact that the filters need maintenance that usually increases the cost of the fluid produced and limits the amount of fluid to be treated. On the one hand, the mesh filter has one main drawback in the need for the washing of the mesh. To remove particles trapped on the surface of the mesh, the mesh is vacuumed, causing a pressure differential opposite to the normal flow. The most efficient way of cleaning these meshes at present is by means of several small-diameter nozzles that run across the surface. The existence of these nozzles and their cleaning process greatly increases the manufacturing and maintenance costs of this type of filter. On the other hand, in the case of ring filters the washing has to be performed simultaneously across the entire filter surface by a change in the direction of the water flow. This causes the filter to stop working as a filter element during washing.

Furthermore, in ring filters there is the problem of the possible separation of the different elements from each other, resulting in a lack of particle selection in the filter. The solution described herein eliminates said problem by joining all the modular elements together with a mechanical fastening that prevents them from separating.

The owner of this specification is aware of various documents that describe filters that perform various functions, such as utility model 1059225U, which describes a self-cleaning filter; model 1056066 U, which describes a similar device; and utility model 1004008 U, which describes a filter capable of incorporating various types of filter surfaces. Various documents are also known relating to modular filter elements, such as 1054796 U, which describes a ring with constant cross-section bottoms and variable section tops; patent ES 2344181 A1, which describes a filter disc with curved channels that cross each other and increase the filter surface.

However, the owner of the invention is not aware of any device similar to that presented in this specification, where the modular filter element makes it possible to guide the water through it using sectors, with the consequent advantages this new feature provides.

The existence of a wide range of solutions is also known for filters using discs with very different structures of microchannels, surfaces and materials that make up the disc to offer different solutions to problems that arise in filter functions. Given the eminently flat shape of this modular element, it will be possible to use all such structures in this invention, where this is not significant for the essence of the invention. Thus, although a perimeter strip with a filter system similar to that of the filter discs described in 1059225U is described in the example realisation below, it would be easy for one skilled in the art to deduce the possibility of using any other filtering system, such as that of patent ES 2344181 A1.

The following is a series of documents that will be discussed in greater depth given their particular relevance:

Document ES2149566T3 describes a filter that includes a pack (28) of substantially flat filter elements stacked one on top of the other, such that each filter element has a shaft centred in position by a cam that passes axially through the pack of filters; with a supply tube for the unfiltered matter passing through the deposit and several intake channels, which are regularly distributed in the perimeter direction of the shaft, leading slightly outwards in radial fashion, supplied by the supply pipe and ending in a circular distribution space from which unfiltered matter flows outwards, slightly perpendicularly to the lateral body of the shaft through an outlet slit, which is positioned radially above the intake channels towards the space between the nearby filter elements and the edge of the circular distribution space, the outlet slit is divided by separation walls into outlet channels.

Although this document describes filter elements fitted with different walls and channels, forming different areas within the surface of the element itself, said features are designed to facilitate the formation of the filter core and they cannot be used to sectorise different flows of the fluid to be filtered.

U.S. Pat. No. 4,501,663A describes a filter formed by a stack of filtration units. In one realisation, the filter unit, which is substantially a flat disc, has two parts fitted together. One is a disc with a flat circular section and concentric strips or protrusions with radial channels cut in said strips. Said circular section is integrated with another outer perimeter circular zone and with another inner circular zone, where the three zones of the disc are concentric.

As in the previous document, the differentiated perimeter strips do not make it possible to separate different flows of the fluid to be treated and the similarity with the invention being proposed lies in the fact that they have different features with different purposes for the treatment of the fluid.

Document GB1096739A describes a filter formed by stacking flat disc-shaped filtering units with a central axial bore and a surface in which a triangular transverse grooved strip extends in zigzag fashion across the face of the circular disc. In one realisation (see FIGS. 8 and 9), the disc may have two distinct concentric areas crossed by different and embedded strips with different shapes.

In this case, the different features lead to different degrees of filtration. Again, no reference is made to the main advantage of the invention of this specification, consisting of the sectorisation of the fluid. By means of the different strips described in said document, this function is not possible.
Document WO2011129746A1 describes a fluid filter formed by the overlapping or stacking of several flat filter elements that define a number of channels with at least two filter levels. The first large filter channels and the second large filter channels extend, generally in radial fashion, across most of the distance between the outer edge of the filter element stack and the central hole. When two-stage filtration is required, the document describes a type of filtering element such as that of FIG. 5, where the disc includes two concentric filter channel layouts: A first filter channel layout in the outer perimeter zone, which is responsible for the first filter stage, trapping the larger particles, a second filter channel layout in the inner zone, which is responsible for the finer filtrate. The shape of the filter elements may also be square, polygonal or any other that is not circular (see FIGS. 4A to 4C). It also describes the possibility of a tandem filter by serially connecting two stacks of elements that can work with the fluid passing through both packages in the same or opposite directions.
As in the previous document, the possibility of sectorising the fluid is not specified.

### DESCRIPTION OF THE INVENTION

The filter element of this application is configured as an eminently flat element, regardless of its external shape, which can be circular, square or any other shape that allows it to adapt to the filter housing to where it has to be fitted.

This modular filter element is intended to be inserted into a filter cartridge, which will be filled with a number of parts identical to the latter to obtain the filter surface necessary for cleaning the fluid as required. Of course, the filter cartridge to be used to obtain the features offered by this modular element must be capable of injecting differentiated flows of fluid in each sector and is therefore not a traditional filter cartridge.

The main specification of this modular filter element is that its surface is formed by perimetric strips of two different shapes. While one of the shapes will be to filter the fluid, the other strip will sectorise the zone through which the fluid passes, such that the water flowing through the different sectors is treated differently and the type of filtering can be varied.

These shapes will consist, on the one hand, of a filtering perimeter strip which, in a possible realisation, has a groove similar to that of the rings used in conventional ring filters, where in the front part there is a zigzag pattern to distribute the water, while at the back there is a groove formed by concentric circles limited to marking the microns of the filter. The other shape consists of a strip with a number of holes separated both radially and in respective concentric sub strips.

By having a number of filter elements, the zig-zag section of one strip of one element will coincide with the concentric grooving of the next element, making the strip the filter zone. The strip of holes makes it possible, after the overlapping of several elements, for independent channels to be created along the filter with different uses but which facilitate the final mechanisms to be used for the automation of the filter. Special mention must be made of the coincidence of the channels of both shapes to achieve an even flow distribution that is also independent in the final filter zones.

The modular filter element in the specification will therefore be formed by at least two strips with different shapes. However, these strips can be repeated as many times as necessary depending on their end use and can therefore have any number of distinct strips, where one of the shapes described will always be alternated with the next since, as described below, the functions of the strips are complementary to each other, which makes it necessary for them to be adjacent to each other.

One of the main advantages of the modular filter element of this specification is that it acts not only as a filter element, but also that the multitude of independent channels created by the peripheral strip of holes makes it possible to re-channel the water to be filtered through them such that a large number of filter and cleaning treatments and operations are possible without the need to modify the filter cartridge configuration.

By being confined in the different channels formed by the holes, the fluid to be filtered can be channelled for different operations in one direction or another, with the possibility of inverse directions in adjacent channels or working according to sectors of the element. In this way, it is possible for one part of the cartridge with the filter elements to function as a filter while another part is performing a cleaning process. Likewise, the depth of the water filter can be increased by collecting in one or more channels the water which has already passed through a grooved strip and returning it to the same grooves as many times as necessary. Thus, in comparison with conventional ring filters, another added advantage of this invention is its great modularity without the need to store several pins in one single pressurised element, offering a mesh density much greater than said conventional elements.

Another possibility of this invention is to have different microns of the grooves in each perimeter strip so that, depending on the filter needs at any given time, a greater or lesser degree of filtration can be used simply by channelling the water to be filtered appropriately until it reaches the desired groove.

The modular filter element is fitted using a mechanical fastening point through several holes in the outermost part. This fastening point ensures there is no relative movement between elements to avoid the risk of them separating.

Since the main and novel feature of the filter element advocated in the specification is its ability to simultaneously perform filter and sectorisation operations on the area through which the fluid passes, different techniques and filtering methods not described in the specification may be used without altering the essence of the invention.

### DESCRIPTION OF THE DRAWINGS

To complement the description that is being made and in order to facilitate better understanding of the specifications of the invention, illustrative, non-restrictive drawings are included as an integral part of this memorandum, described as follows:

FIG. 1. A layout view of the front of the modular filter element. Here, said element has three perimeter strips, where the outer strip and the inner strip consist of grooves of different microns for the filter of the water, while the intermediate strip consists of holes arranged in pairs and spaced from each other, where the holes positioned further to the exterior are connected to the outer perimeter strip and those positioned in the interior are connected to the inner perimeter strip. Each strip has been enlarged in the figure to make it easier to see.

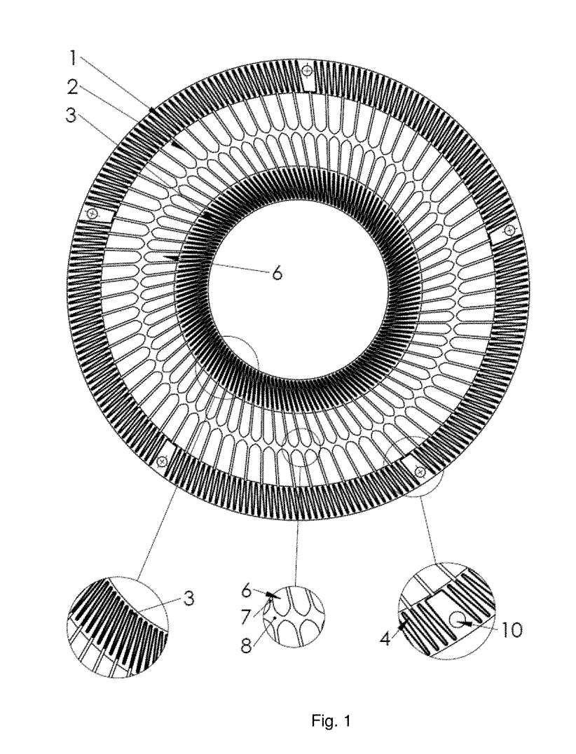

FIG. 2. A layout view of the front part of the element of the previous figure, with an enlarged view of the concentric grooving of the outermost strip.

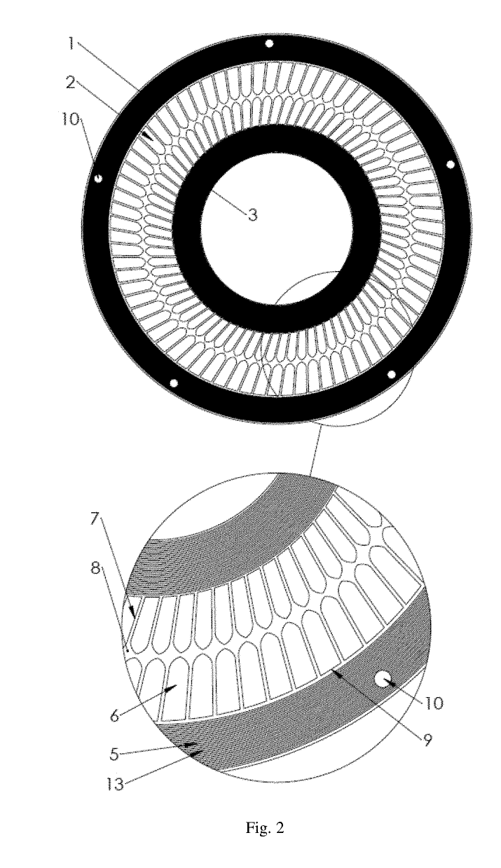

FIG. 3. The isometric of a set of assembled elements is shown forming a filter surface ready to be inserted in a filter cartridge.

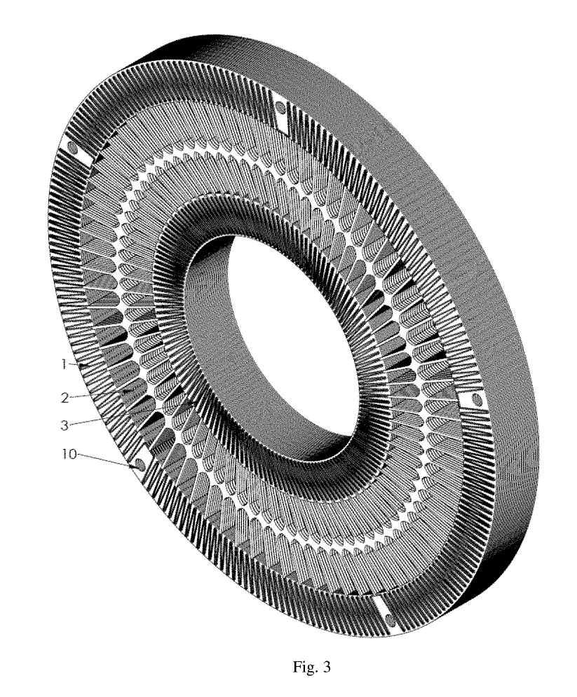

### DESCRIPTION OF THE PREFERRED REALISATION

In view of the aforementioned figures and according to the numbering system that is adopted, they show a preferred realisation of the invention, which comprises the parts and elements indicated and described in detail below, where this example does not aim to limit the scope thereof in any way.

The modular filter element is formed as a 1 mm-thick circular crown whose surface has three distinct perimeter strips. In this example, as the filtering element is circular, the strips form concentric circles; however, the base geometry can be of any type, conditioned only by the geometry of the cartridge in which the set of elements to be assembled is to be inserted.

The outer perimeter strip (1) has a zig-zag groove (4) formed by a relief that protrudes 0.5 mm above the base of the circular crown and whose raised parts rest on the concentric groove (5) of the front part of the perimeter strip (1) of the attached modular filter element. Said concentric grooves will have a height of 0.01 mm and a crest spacing of 0.01 mm

The zigzag of the groove (4) of the outer perimeter strip (1) will be occasionally interrupted by the holes for the mechanical fastening (10) of the elements, continued at said points by straight lines and returning to the previous shape once the hole for the mechanical fastening has been exceeded (10).

After the outer perimeter strip (1), there is an intermediate perimeter strip (2) with a series of holes (6) defined by a number of walls separated in radial fashion (7). These holes (6) are divided into two strips, one outer and one inner, by means of a concentric separating wall (8) arranged in the central part of the intermediate strip (2).

Both the radial (7) and concentric (8) walls will have a height relative to the base of the circular crown equal to that of the radial groove (4) of the outer (1) and inner (3) perimetric strips, and their shapes will be such that they will be stackable, where the walls of one element fits into those of the attached filter elements to prevent them from moving. Thus, joining together the filter elements will create, by means of the holes (6), a series of channels through which the water will flow.

Finally, in the inner part of the crown, there is a new inner perimeter strip (3) which will have a configuration similar to that of the outer perimeter strip (1), modifying the relief of the radial and concentric grooves of the front and rear parts, respectively.

The transition between two different types of strip is made in such a way that the radial walls (7) connect at the front part of the element with the proximal end of the radial groove (4) to form a closed space from which the water flowing through the channels formed by the holes (6) can come out only through the grooves of the outer and inner perimeter strips. At the rear of the element, the radial walls (7) will be connected to the closure walls (9) positioned parallel to the concentric grooves (5), such that the latter is separated from the hole to force the water through the front part of the filter element.

An example of the advantages offered by this element may be the possibility of using the channels created by the holes (6) of the intermediate strip (2) to carry water separately, taking water through the outer holes for filtering through the outer perimeter strip (1) while, at the same time, the inner part washes the inner perimeter strip (3) by forcing water from the inner part of the crown through said inner perimeter strip (3) and dislodging the water with debris through the channels created by the strip of inner holes without it coming into contact with the filter water flowing simultaneously through the channels created by the outer holes of the intermediate strip (2). Once the wash cycle has been completed, the direction of the water flow can be alternated to clean the outer perimeter strip (1) while the inner perimeter strip (3) performs the filter functions.

1. Modular sectorised filtering element configured as a flat element with a circular crown shape or any other type of exterior shape (square, polygon, etc.) intended to form a filter surface by stacking a number of identical elements on a common axis. The elements are characterised in that their surface is formed by a number of strips that are concentric to the axis that will have at least two different shapes. One of them consists of grooving or relief defining a number of filter channels mostly with a radial direction while the other shape consists of concentric strips formed by a number of independent holes defined by a number of separation walls where each of the holes has at least one connection zone with the perimeter strip of filter channels, where both strips are radially aligned with respect to the sectorisation for the radial separation of the different channels across the entire element.

2. Modular sectorised filtering element according to claim 1, characterised in that each of the strips forming the channels has grooves at the front in a zigzag formed by a relief that protrudes over the circular crown and whose raised parts are set on concentric grooves located on the opposite side of the perimetric strip of the attached modular filter element.

3. Modular sectorised filtering element according to claim 1, characterised in that the holes are delimited by walls, which completely surround the hole in the front part of the element except in the area of the latter that is closest to the strip of filter channels, where the walls are open to allow the fluid from the filter channels into the strip holes to the other through said openings.

4. Modular sectorised filtering element according to claim 1, characterised in that the holes are arranged in two concentric strips delimited by a concentric separating wall that is mostly circular in shape.

5. Modular sectorised filtering element according to claim 1, characterised in that at the rear of the element the radial walls will be connected with closing walls positioned parallel to the concentric grooves, isolating the hole from the strip of filter channels.

6. Modular sectorised filtering element according to claim 1, characterised in that the walls are stackable, thus fitting the walls of an element to those of the attached filter elements.

7. Modular sectorised filtering element according to claim 1, characterised in that the end strips (the outermost and the innermost) are of the grooved type.

8. Modular sectorised filtering element according to claim 1 characterised in that the numerous modular filter elements are fastened in place by a mechanical fastening system through different holes arranged in the outermost part.
